(19) United States
(12) Patent Application Publication
(10) Pub. No.: US 2016/0098431 A1
(43) Pub. Date: Apr. 7, 2016

(54) PERFORMING MATHEMATICAL OPERATIONS ON CHANGED VERSIONS OF DATA OBJECTS VIA A STORAGE COMPUTE DEVICE

(71) Applicant: Seagate Technology LLC, Cupertino, CA (US)

(72) Inventors: David Scott Ebsen, Minnetonka, MN (US); Ryan James Goss, Prior Lake, MN (US); Jeffrey L. Whaley, Minneapolis, MN (US); Dana Simonson, Owatonna, MN (US)

(21) Appl. No.: 14/506,950

(22) Filed: Oct. 6, 2014

(51) Int. Cl. G06F 17/30; G06F 17/16

(52) U.S. Cl. CPC G06F 17/30309; G06F 17/16

(57) ABSTRACT

A data object is received from a host and stored on a storage compute device. A first mathematical operation is performed on the data object via the storage compute device. An update from the host is received and stored on the storage compute device. The update data is stored separately from the data object and includes a portion of the data object that has subsequently changed. A second mathematical operation is performed on a changed version of the data object using the update data.

### SUMMARY

The present disclosure is related to performing mathematical operations on changed versions of data objects via a storage compute device. In one embodiment, a method involves receiving and storing a data object from a host. A first mathematical operation is performed on the data object via a storage compute device. An update from the host is received and stored, the update data stored separately from the data object and including a portion of the data object that has subsequently changed. A second mathematical operation is performed on a changed version of the data object using the update data. The method may be implemented on a storage compute device and system.

These and other features and aspects of various embodiments may be understood in view of the following detailed discussion and accompanying drawings.

### BRIEF DESCRIPTION OF THE DRAWINGS

In the following diagrams, the same reference numbers may be used to identify similar/same components in multiple figures. The drawings are not necessarily to scale.

FIG. 1 is a block diagram of a storage compute device according to an example embodiment;

FIGS. 2-4 are block diagrams showing storing and updating of host objects on a storage compute device according to an example embodiment;

FIG. 5 is a sequence diagram illustrating a computation according to an example embodiment;

FIG. 6 is a block diagram of a system according to an example embodiment; and

FIG. 7 is a flowchart of a method according to an example embodiment.

### DETAILED DESCRIPTION

Some computational tasks are suited for massively distributed computing solutions. For example, data centers that provide web services, email, data storage, Internet search, etc., often distribute tasks among hundreds or thousands of computing nodes. The nodes are interchangeable and tasks may be performed in parallel by multiple computing nodes. This parallelism increases processing and communication speed, as well as increasing reliability through redundancy. Generally, the nodes may include rack mounted computers that are designed to be compact and power efficient, but otherwise operate similarly to desktop computer or server.

For certain types of tasks, it may be desirable to rearrange how data is processed within the individual nodes. For example, applications such as neuromorphic computing, scientific simulations, etc., may utilize large matrices that are processed in parallel by multiple computing nodes. In a traditional computing setup, matrix data may be stored in random access memory and/or non-volatile memory, where it is retrieved, operated on by relatively fast central processor unit (CPU) cores, and the results sent back to volatile and/or non-volatile memory. It has been shown that the bus lines and I/O protocols between the CPU cores and the memory can be a bottleneck for some types of computation.

This disclosure generally relates to use of a data storage device that performs internal computations on data on behalf of a host, and is referred to herein as a storage compute device. While a data storage device, such as a hard drive, solid-state drive (SSD), hybrid drive, etc., generally includes data processing capabilities, such processing is mostly related to the storage and retrieval of user data. So while the data storage device may perform some computations on the data, such as compression, error correction, etc., these computations are invisible to the host. Similarly, other computations, such as logical-to-physical address mapping, involve tracking host requests, but are intended to hide these tracking operations from the host. In contrast, a storage compute device makes computations based on express or implied computation instructions from the host, with the intention that some form of a result of the computation will be returned to the host and/or be retrievable by the host.

While a storage compute device as described herein may be able to perform as a conventional storage device, e.g., handling host data storage and retrieval requests, such storage compute devices may include additional computational capability that can be used for certain applications. For example, scientific and engineering simulations may involve solving equations on data objects such as very large matrices. Even though the matrices may be sparse, and therefore amenable to a more concise/compressed format for storage, the matrices may still be cumbersome to move in and out of storage for performing operations. For example, if available volatile, random access memory (RAM) is significantly smaller than the objects being operated on, then there may be a significant amount of swapping data between RAM and persistent storage.

While a conventional storage device can be used to store data objects, such device may not be given information that allows it to identify the objects. For example, host interfaces may only describe data operations as acting on logical block addresses (or sectors), to which the storage device translates to a physical address. In contrast, a storage compute device will obtain additional data that allows the storage device to manage the objects internally. This management may include, but is not limited to, selection of storage location, managing of object identifiers and other metadata (e.g., data type, extents, access attributes, security attributes), compression, and performance of single or multiple object computations and transformations.

In embodiments described below, a storage compute device includes two or more compute sections that perform computations on computation objects. For purposes of this discussion, computation objects may at least include objects that facilitate performing computations on data objects. Computation objects may include stored instructions, routines, formulas, definitions, etc., that facilitate performing repeatable operations. A computation object may include data objects, such as scalars/constants that are utilized in all of the relevant computations and accessible by the compute section (e.g., using local or shared volatile memory). Other data objects are used as inputs and outputs of the computations, and may also include temporary objects used as part of the computations, e.g., intermediate computation objects. While the examples below may refer to matrix data objects, the term “data object” as used herein is not intended to be limited to matrices. It will be understood that the embodiments described herein may be used to perform computations on other large data sets, such as media files/streams, neural networks, etc.

In storage compute devices described below, a controller receives and stores a computation object and one or more data objects from a host. The computation object defines a mathematical operation that is then performed on the one or more data objects. The host provides update data from the host, the update data including a sub- set of the data object that has subsequently changed. The mathematical operations are repeated on a changed version of the one or more data objects using the update data.

These features of a storage compute device can be used for operations where the device needs to repeat the same analysis at intervals as the data changes. The data may be changing slowly or quickly. For example, the storage device computation may be part of a larger iterative computation, which may involve repeating of the same calculation with incrementally updated objects. By incrementally updating currently stored objects instead of replacing them, performance can be improved and data storage requirements reduced. This may also provide other features, such as point-in-time snapshots and versioning.

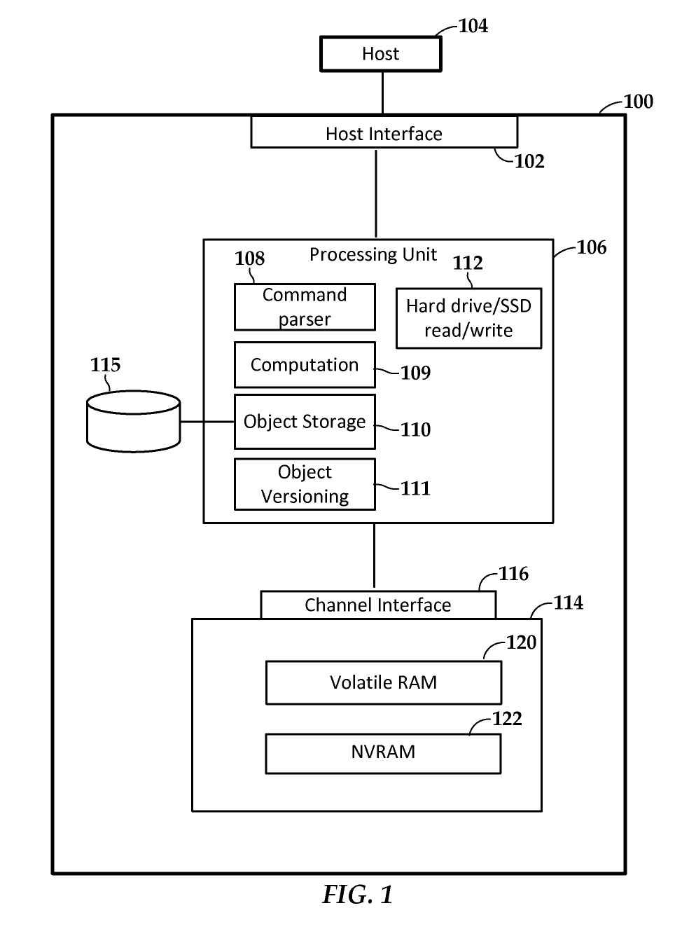

In FIG. 1, a block diagram shows a storage compute device 100 according to an example embodiment. The storage compute device 100 may provide capabilities usually associated with data storage devices, e.g., storing and retrieving blocks of data, and may include additional computation abilities as noted above. Generally, the storage compute device 100 includes a host interface 102 configured to communicate with a host 104. The host interface 102 may use electrical specifications and protocols associated with existing hard drive host interfaces, such as SATA, SaS, SCSI, PCI, Fibre Channel, etc., and/or network interfaces such as Ethernet.

The storage compute device 100 includes a processing unit 106. The processing unit 106 includes hardware such as general-purpose and/or special-purpose logic circuitry configured to perform functions of the storage compute device 100, including functions indicated in functional blocks 108-112. Functional block 112 provides legacy storage functionality, such as read, write, and verify operations on data that is stored on media. Blocks 108-111 represent specialized functionalities that allow the storage compute device 100 to provide internal computations on behalf of the host 104.

Block 108 represents a command parser that manages object-specific and computation-specific communications between the host 104 and storage compute device 100. For example, the block 108 may process commands that define objects (matrices, vectors, scalars, sparse distributed representations) and operations (e.g., scalar/matrix mathematical and logical operations) to be performed on the objects. A computation section 109 performs the operations on the objects, and may be specially configured for a particular class of operation. For example, if the storage compute device 100 is configured to perform a set of matrix operations, then the computation section 109 may be optimized for that set of operations. The optimization may include knowledge of how best to store and retrieve objects for the particular storage architecture used by the storage compute device 100, and how to combine and compare data objects.

An object storage module 110 manages object creation, storage, and access on the storage compute device 100. This may involve, among other things, storing metadata describing the objects in a database 115. The database 115 may also store logical and/or physical addresses associated with the object data. The object storage module 110 may manage other metadata associated with the objects via the database 115, such as permissions, object type, host identifier, local unique identifier, etc.

An object versioning module 111 manages host-initiated changes to stored data objects. The host 104 may issue a command that causes a data object currently stored on the storage compute device 100 to be changed. This may involve deleting or keeping the older version of the object. For example, if the data object is a matrix, the change command could include a first array of matrix row/column indicators and a second array with data values associated with the row/column indicators. The changes may be specified in other ways, such as providing a sub-array (which may include single rows or columns of data) and an index to where the sub-array is to be placed in the larger array to form the updated version.

As noted above, the functional blocks 108-112 may at some point will access persistent storage, and this can be done by way of a channel interface 116 that provides access to the storage unit 114. There may be a multiple channels, and there may be a dedicated channel interface 116 and computation section 109 for each channel. The storage unit 114 may include both volatile memory 120 (e.g., DRAM and SRAM) and non-volatile memory 122 (e.g., flash memory, magnetic media). The volatile memory 120 may be used as a cache for read/write operations performed by read/write block 112, such that a caching algorithm ensures data temporarily stored in volatile memory 120 eventually gets stored in the non-volatile memory 122. The computation section 109 may also have the ability to allocate and use volatile memory 120 for calculations. Intermediate results of calculations may remain in volatile memory 120 until complete and/or be stored in non-volatile memory 122.

As noted above, it is expected that data objects may be too large in some instances to be stored in volatile memory 120, and so may be accessed directly from non-volatile memory 122 while the calculation is ongoing. While non-volatile memory 122 may have slower access times than volatile memory 120, it still may be more efficient to work directly with non-volatile memory 122 rather than, e.g., breaking the problem into smaller portions and swapping in and out of volatile memory 120.

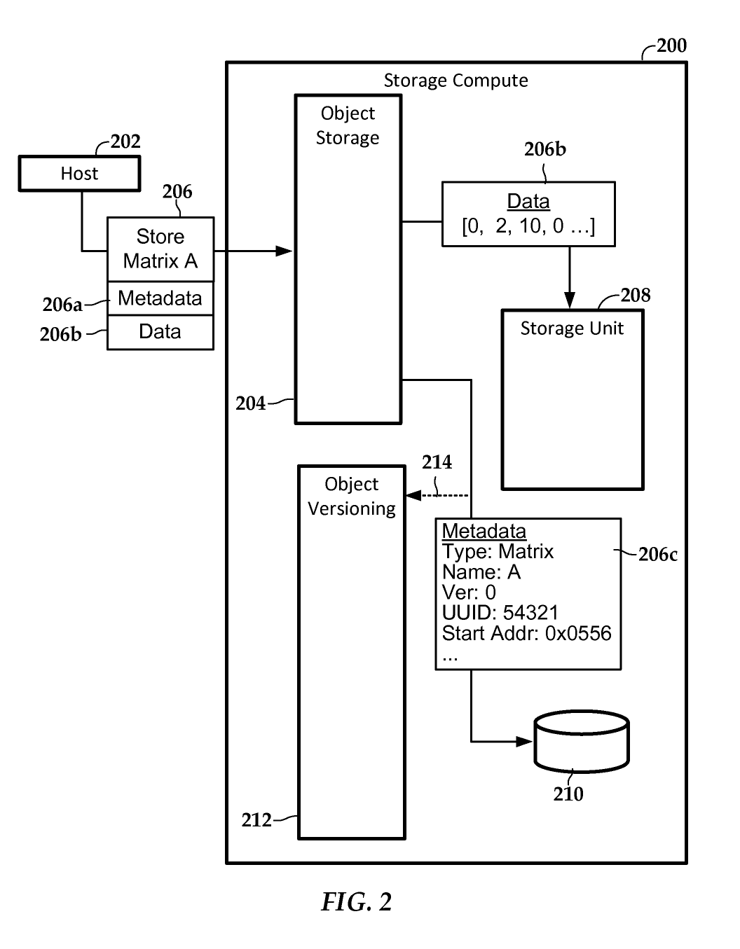

In FIGS. 2-4, block diagrams illustrate storing and updating of host objects on a storage compute device 200 according to an example embodiment. A host 202 communicates via a host interface (not shown) with an object storage component 204 of the storage compute device 200. In this example, the host 202 is sending to the object storage component 204 a command 206 to store a matrix data object. The command 206 includes metadata 206a and data 206b of the stored object. In this example, the metadata 206a may include an identifier (e.g., “Matrix A”), a description of the size of the matrix, etc. The data 206 may include a data structure (e.g., delimited list, packed array) that includes values of at least some of the matrix entries. The matrix may be stored in a compressed format. For example, if the matrix is sparse (mostly zeros) a compressed format may only describes a subset of the entries, and the rest of the entries are assumed to be zero. A number of compressed matrix formats are known in the art.

As seen in FIG. 2, the command 206 results in the data 206b being stored in a primary storage unit 208 (e.g., mass storage unit). In this example, the data 206b is not significantly changed before storage, although in some cases the object storage component 204 may change the data, such as by removing delimiters, further compression, etc. A changed version of the metadata 206c is stored in a database 210. The database 210 may part of the storage unit 208, e.g., a reserved file or partition, or may be a separate storage device. Generally, the object storage component 204 adds additional data to the host-supplied metadata 206a to form the changed metadata 206c. The additional data may include internal identifiers, start address of the storage unit 208 where the data 206b can be found, size of the data 206b, version, etc.

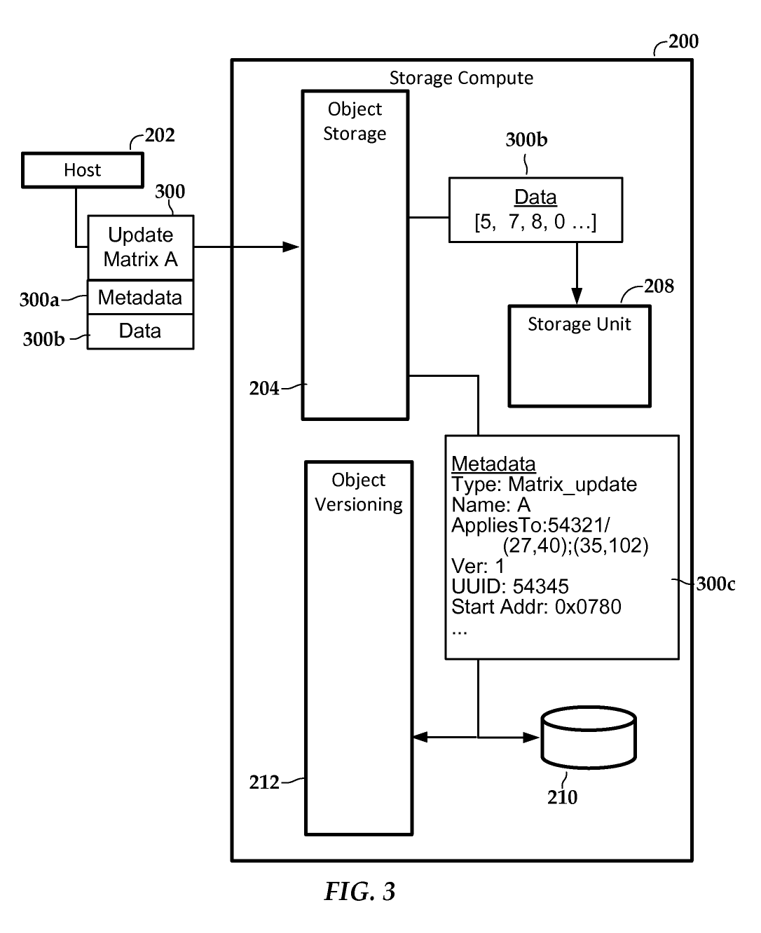

The versioning data within the metadata 206c will be of interest to an object versioning component 212. The object versioning component 212 may receive a communication, as indicated by dashed line 214, when the object is created, or at least when the object is changed. In one configuration, the objects may receive a default initial revision upon creation, and the object versioning component 212 may only need to track versions after updates occur. An example of updating the illustrated matrix is shown in FIG. 3.

In FIG. 3, a host command 300 includes metadata 300a and data 300b. This appears similar to the matrix creation command 206 in FIG. 2, except as can be seen in modified metadata 300c, the command type indicates it is an update, and the “applies to” field gives a unique ID and range within the original object (or other version of the object) to which the update applies. The object storage component 204 will add other data to create the updated metadata 300c, such as an address within the storage unit 208 where the data 300b is stored. As with the original command 206, the data 300b of command 300 may be modified before storage or stored as-is, the latter being shown here.

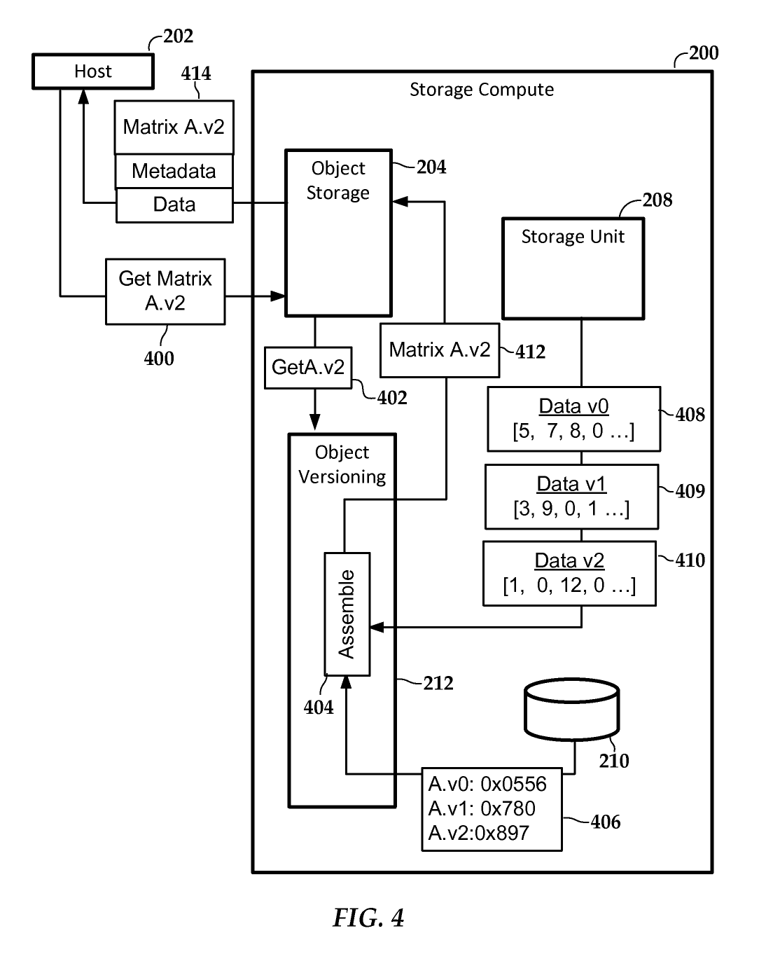

In FIG. 4, a block diagram illustrates how a version of stored matrix from FIGS. 2 and 3 can be retrieved. In this example, the host 202 sends a request 400 for a particular version of the matrix that was previously stored and updated. The object storage component 204 receives the request 400 and sends its own request 402 to the object versioning component 212. In response, the object versioning component 212 performs an assembly operation 404 to provide the requested version.

The assembly operation 404 involves retrieving metadata 406 from the database 210. The metadata 406 at least includes information regarding where particular portions 408-410 of the matrix data are accessed in the storage unit 208. The metadata 406 may also include indicators of where the data portions are inserted into a base version, identifiers, names, timestamps, and/or events associated with the particular version, etc. The metadata 406 may be indexed via a unique identifier associated with the data object, e.g., provided in the host request 400.

Based on the metadata 406, the object versioning component 212 assembles the data portions 408-410 into the requested version 412 of the data object. This version 412 may be further processed (e.g., adding other metadata, formatting) to form a data object 414 that passed to the host 202 in response to the request 400. It will be understood that the host 202 need not be aware that the requested object is versioned. Each version may have its own unique identifier, and the host 202 need not be aware of the assembly processed used to retrieve a particular version. Also, while the example of a host request is used here for purposes of illustration, forming particular versions of objects may be performed in response to internal request. For example, the host 202 may load initial objects to the storage compute device 200 and specify particular, repeated operations to be performed on the initial objects. For each iteration, the storage compute device 200 may decide internally to use versioned objects to perform the repeated operations, or may do so at the request of the host 202.

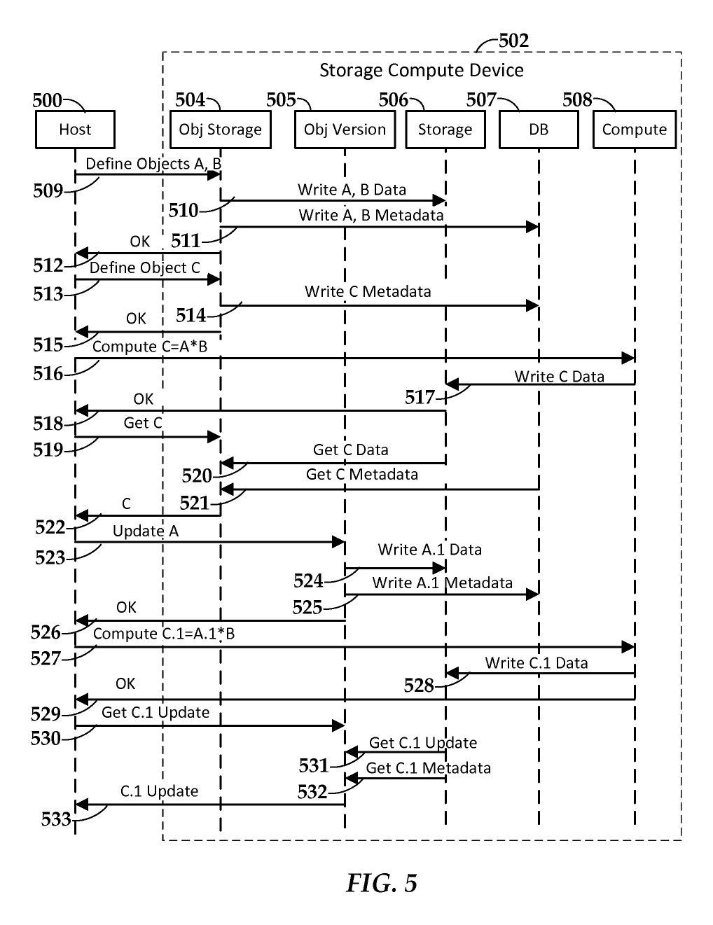

While versioned objects are described as being changed by host commands such as shown in FIG. 2, the storage compute device 200 may also communicate resultant objects to the host 202 by way of difference data. An example of this is shown in the sequence diagram of FIG. 5. A host 500 and storage compute device 502 are configured to have functionality similar to analogous components described in FIGS. 1-4. The storage compute device 502 includes functional components 504-508 similar to those of storage compute device 100 in FIG. 1. The host 500 sends a command 509 to an object storage component 504 that defines two objects, e.g., matrix objects. The command 509 may include multiple commands, and are combined here for conciseness.

In response to the command(s), the object storage component 504 writes data 510 of the objects to a storage unit 506 and writes metadata 511 of the objects to a database 507. The object storage component 504 then provides an acknowledgement 512 of success. The host 500 also defines a third object via command 513. This object is different in that it is a resultant of a computation, and so the object storage component 504 only writes metadata 514 of the object. The object storage component 504 may also perform other actions that are not shown, such as allocating space in the storage unit 506 and initializing the allocated space.

The host 500 sends a computation command, e.g., computation object 516, to a compute engine 508 that causes the compute engine 508 to multiply the first two objects A and B and put the result in the third object C. When complete, the compute engine 508 writes the result 517 to the storage unit 506 and acknowledges 518 completion with the host 500. Thereafter, the host gets the resultant object C via commands/actions 519-522. In this case, the resultant object may be part of a larger, iterative computation performed via a number of storage compute devices and/or hosts. In response to this iteration, the value of one of the inputs to the computation, object A, are changed.

This change to object A is communicated to the storage compute device 502, here by command 523 shown being directly sent to an object versioning component 505. The object versioning component 505 saves the update data 524 and metadata 525 and acknowledges 526 completion. Thereafter, the host 500 performs the same computation as was performed by computation object 516, except as seen by computation object 527, the computation involves the next version of the object A and the result is the next version of object C. The computation object 527 may be a stored version of the earlier computation object 516, but expressly or impliedly applied to the new versions as indicated.

While not shown in this diagram, performance of computation 527 may involve the object versioning component 505 providing an updated version of the input object A (now labeled A.1) to the compute engine 508. An example of this is shown and described above in relation to FIG. 4. After completion of the computation, the compute engine 508 writes the updated resultant object 528 (C.1) to the storage unit 506, and acknowledges 529 completion. This result 528 may be in the form of a full version of C.1 or just the changes from the original object C. In some cases, the compute engine 508 may utilize knowledge of object versioning/changes to more efficiently compute and store the results. For example, if the computation is a multiplication of matrices as shown here, only the changed rows and columns of A.1 need to be multiplied with object B, and this will only result in changing a corresponding set of elements in the resultant matrix C.1. As a result, the compute engine 508 may be configured to store the results 528 as a different version (e.g., deltas from the original) using similar conventions as the object versioning component 505.

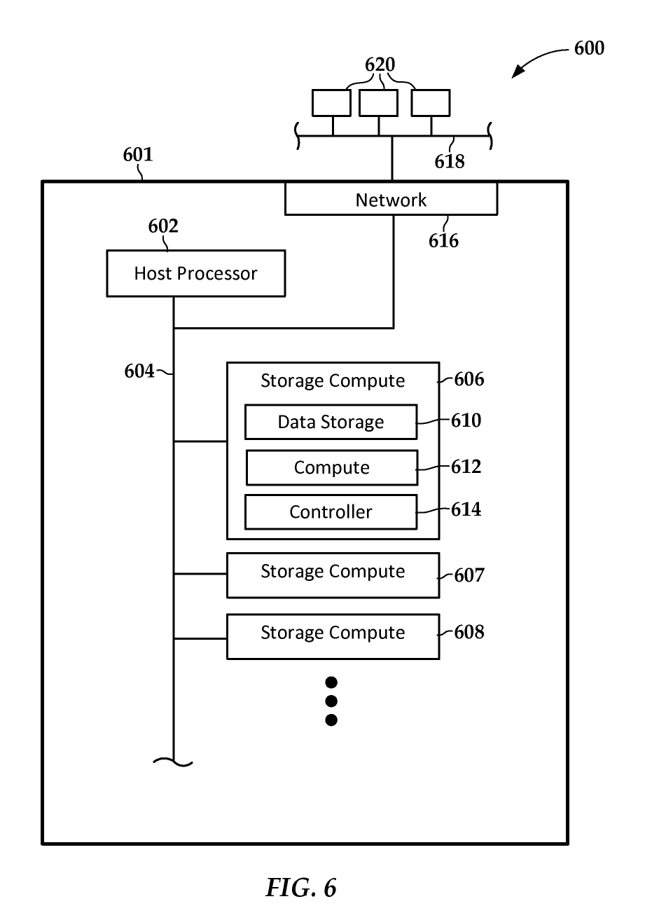

After completion of the computation, the host 500 requests update data for the resultant object C.1 via computation object 530. Because this is a request for only the changes from a different version of object C, this computation object 530 is processed by the object versioning component 505, which retrieves the data via actions 531-533 in a similar way as the original object was retrieved via actions 520-522. The difference is that the data 533 received by the host 500 just represents the difference from the original object 522 earlier received, and it is up to the host 500 to apply the changes to obtain the full resultant object C.1. If the host 500 and storage compute device 502 are part of a larger system that is solving a distributed problem, then communicating just the changes between iterations may be sufficient to solve some types of problems. Such a system is shown in FIG. 6.

In reference now to FIG. 6, a block diagram illustrates a system 600 according to an example embodiment. The system includes a host device 601 with a host processor 602 that is coupled to a data bus 604. The data bus 604 may include any combination of input/output transmission channels, such as southbridge, PCI, USB, SATA, SaS, etc. One or more storage compute devices 606-608 are coupled to the data bus 604. As shown for storage compute device 606, each of the devices 606-608 includes a data storage section 610 that facilitates persistently storing data objects on behalf of the host processor. The data objects being internally managed by the storage compute device 606. The storage compute devices 606-608 include one or more compute sections 612 that perform computations on the data objects, and a controller 614.

The controller 614 receives from the host processor a data object, which is stored in the storage section 610. The compute section 612 performs a first mathematical operation on the data objects. Thereafter, the controller 614 receives update data from the host processor 602. The update data includes a portion of the data object that has subsequently changed. The update data may be stored in the storage section 610 separate from the data object. The compute section 612 then performs a second mathematical operation on a changed version of the one or more data objects using the update data. The changed version may be assembled dynamically for use in the calculation based on the original version plus any update data for the target version and intermediary versions.

The storage compute devices 606-608 may be able to coordinate communicating of object data and distribution of parallel tasks on a peer-to-peer basis, e.g., without coordination of the host processor 602. In other arrangements, the host processor 602 may provide some or all direction in dividing inter-host distribution of tasks in response to resource collisions. The host device 601 may be coupled to a network 618 via network interface 616. The tasks can also be extended to like-configured nodes 620 of the network 618, e.g., nodes having their own storage compute devices. If the distribution of tasks extends to the nodes 620, then the host processor 602 may generally be involved, at least in providing underlying network services, e.g., managing access to the network interface, processing of network protocols, service discovery, etc.

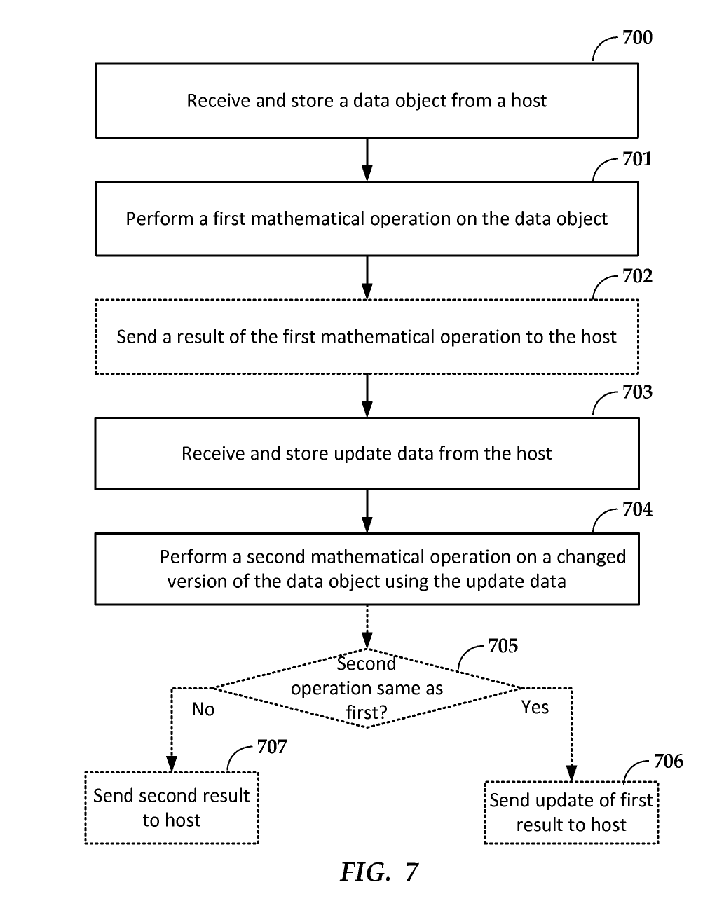

In reference now to FIG. 7, a flowchart shows a method according to an example embodiment. The method involves receiving and storing 700 a data object from a host. A first mathematical operation is performed 701 on the data object. A result of the mathematical operation may be sent 702 to the host. Update data from the host is received and stored 703. The update data is stored separately from the data object and includes a portion of the data object that has subsequently changed. A second mathematical operation is performed 704 on a changed version of the data object using the update data. If the second mathematical operation is the same as the first as indicated in optional block 705, an update of the first result may be sent 706 to the host, if needed. Otherwise, the second result may be sent 707 if needed by the host.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a non-transitory computer-readable medium and transferred to the processor for execution as is known in the art.

The foregoing description of the example embodiments has been presented for the purposes of illustration and description. It is not intended to be exhaustive or to limit the inventive concepts to the precise form disclosed. Many modifications and variations are possible in light of the above teaching. Any or all features of the disclosed embodiments can be applied individually or in any combination and are not meant to be limiting, but purely illustrative. It is intended that the scope be limited not with this detailed description, but rather determined by the claims appended hereto.

What is claimed is:

1. A method comprising:
receiving and storing a data object from a host;
performing a first mathematical operation on the data object via a storage compute device;
receiving and storing update data from the host, the update data stored separately from the data object and comprising a portion of the data object that has subsequently changed; and
perform a second mathematical operation on a changed version of the data object using the update data.

2. The method of claim 1, wherein the changed version is created dynamically while performing the second mathematical operation.

3. The method of claim 1, wherein performing the second mathematical operation comprises repeating the first mathematical operation.

4. The method of claim 3, further comprising:
providing to the host a result of the first mathematical operation; and
after performing the second mathematical operation on the changed version, providing result update data to the host that comprises a portion of the result that has changed in response to repeating the first mathematical operation.

5. The method of claim 3, wherein performing the mathematical operation on the changed version of the data object comprises performing the second mathematical operation on only the portion of the data object that has subsequently changed.

6. The method of claim 1, wherein the data object comprises a matrix.

7. The method of claim 1, further comprising:
receiving a request from the host for the changed version of the data object;
applying the update data to the data object to create the changed version; and
sending the changed version to the host.

8. A storage compute device comprising:
a host interface that receives a data object and update data from a host, the update data comprising a portion of the data object that has subsequently changed;
a storage unit that separately stores the data object and the update data; and
a processing unit coupled to the host interface and the storage unit, the processing unit configured to:
perform a first mathematical operation on the data object; and
perform a second mathematical operation on a changed version of the data object using the update data.

9. The storage compute device of claim 8, wherein the changed version is created dynamically while performing the second mathematical operation.

10. The storage compute device of claim 8, wherein performing the second mathematical operation comprises repeating the first mathematical operation.

11. The storage compute device of claim 10, wherein the processing unit is further configured to:
provide to the host a result of the first mathematical operation; and
after performing the second mathematical operation on the changed version, provide result update data to the host that comprises a portion of the result that has changed in response to repeating the first mathematical operation.

12. The storage compute device of claim 10, wherein performing the mathematical operation on the changed version of the data object comprises performing the second mathematical operation on only the portion of the data object that has subsequently changed.

13. The storage compute device of claim 8, wherein the data object comprises a matrix.

14. The storage compute device of claim 8, wherein the processing unit is further configured to:
receiving a request from the host for the changed version of the data object;
applying the update data to the data object to create the changed version; and
sending the changed version to the host.

15. A system comprising:
a host processor; and
at least one storage compute device comprising a processing unit coupled to the host processor, the processing unit configured to:
receive and store a data object from the host processor;
perform a first mathematical operation on the data object;
receive and store update data from the host processor, the update data stored separately from the data object and comprising a portion of the data object that has subsequently changed; and
perform a second mathematical operation on a changed version of the data object using the update data.

16. The system of claim 15, wherein performing the second mathematical operation comprises repeating the first mathematical operation.

17. The system of claim 16, further comprising:
providing to the host a result of the first mathematical operation; and
after performing the second mathematical operation on the changed version, providing result update data to the host that comprises a portion of the result that has changed in response to repeating the first mathematical operation.

18. The system of claim 16, wherein performing the mathematical operation on the changed version of the data object comprises performing the second mathematical operation on only the portion of the data object that has subsequently changed.

19. The system of claim 15, wherein the at least one storage compute device comprises a plurality of storage compute devices, and wherein the first and second mathematical operations are part of an iterative computation distributed among the plurality of storage compute devices.

20. The system of claim 15, further comprising a network interface capable of being coupled to a network node comprising a remote storage compute device and wherein the first and second mathematical operations are part of an iterative computation distributed between the host processor and the network node.
